(19) United States
(12) Patent Application Publication
(10) Pub. No.: US 2008/0162469 A1
(43) Pub. Date: Jul. 3, 2008

(54) CONTENT REGISTER DEVICE, CONTENT REGISTER METHOD AND CONTENT REGISTER PROGRAM

(76) Inventors: Hajime TERAYOKO, Saitama (JP); Yasumasa MIYASAKA, Kanagawa (JP)

Correspondence Address: BIRCH STEWART KOLASCH & BIRCH, PO BOX 747, FALLS CHURCH, VA, 22040-0747, US

(21) Appl. No.: 11/964,591

(22) Filed: Dec. 26, 2007

(30) Foreign Application Priority Data
Dec. 27, 2006 (JP) 2006-351157

(51) Int. Cl. G06F 17/30

(52) U.S. Cl. 707/5; 707/E17.001

(57) ABSTRACT

A tag production section analyzes an image file input from an image input section and extracts characteristics such as characteristic colors, time information, and location information. A word table stores various characteristics and keywords representing these characteristics in association with each other. A keyword selecting section searches the word table based on the extracted characteristics and selects corresponding keywords. An associated word acquiring section searches a thesaurus for associated words of the keywords. A score acquiring section acquires a score representing the degree of association between the associated word and the keyword. In an image database, the image file having a tag on which the keywords are described, the associated words, and the score added are registered.

### FIELD OF THE INVENTION

The present invention relates to a content register device, a content register method and a content register program, and particularly relates to a content register device, a content register method and a content register program for registering content after adding a tag for search to the content.

### BACKGROUND OF THE INVENTION

In a database for managing content such as images, the content is stored with metadata like keywords associated to the content, and the target content is obtained by searching the keywords. The keywords are registered by a person who registers the content. When there are a lot of content to be registered, it is cumbersome to register the keywords. In addition, the registered keywords are selected based on subjectivity of the person who registers the content, and the keywords used for search are selected based on subjectivity of people who search the content (herein after, searcher). When the person who registers the content and the searcher select different keywords with respect to an identical content, the target content may not be easily searched.

In order to solve the difficulty of search based on the keywords selection, in a publication of Japanese Patent Laid-open Publication No. 10-049542, one part of an input image is analyzed, and keywords such as “tree”, “human face” and the like are extracted from shape, colors, size, texture, and so on of this part. The keywords are then registered in association with the image. In a publication of Japanese Patent Laid-open Publication No. 2002-259410, metadata of content like an image, and feature quantity of the content are managed separately. When a new image is registered in a database, metadata of a previously input image that has similar feature quantity as the new image is given to the new image.

According to the invention disclosed in the Japanese Patent Laid-open Publication No. 10-049542, since the keywords are automatically extracted, the keywords can be known by analogy when the extraction method is understood, and therefore percent hit rate in search can be improved. However, since the keywords are limited to those extracted from the image, a broad-ranging search cannot be performed.

According to the invention disclosed in the Japanese Patent Laid-open Publication No. 2002-259410, since the preliminary registered metadata is used for the newly input content, quite a few content needs to be stored so that adequate metadata can be used for the newly input content, otherwise the search accuracy cannot be improved.

### SUMMARY OF THE INVENTION

It is an object of the present invention to provide a content register device, a content register method and a content register program, for automatically providing content with keywords which enable an accurate b-road-ranging search of the content even with a small amount of registered data.

In order to achieve the above and other objects, a content register device of the present invention includes a content input device, a tag production device, a thesaurus, an associated word acquiring device, a score acquiring device, and a content database. When content is input by the content input device, the tag production device automatically produces a tag in which a keyword representing characteristics of the content is described. In the thesaurus, words are sorted and arranged in groups that have similar meanings. The associated word acquiring device acquires an associated word of the keyword by searching the thesaurus. The score acquiring device acquires a score representing the degree of association between the associated word and the keyword with use of the thesaurus. The content database registers the content, the tag, the associated word and the score in association with each other.

The tag production device includes a characteristics extracting section, a word table, and a keyword selecting section. The characteristics extracting section extracts the characteristics that can become the keyword by analyzing the content or metadata attached to the content. In the word table, the characteristics and a word are stored in association with each other. The keyword selecting section selects a word corresponding to the characteristics by searching the word table and describes the word as the keyword in the tag.

When the content is an image, the characteristics extracting section extracts at least one characteristic color of the image. The word table stores the characteristic color and a color name in association with each other. The keyword selecting section selects a color name corresponding to the characteristic color by searching the word table and describes the color name as the keyword in the tag.

The tag production section may include an image recognizing section and an object name table. The image recognizing section recognizes a kind and/or a shape of an object in the image. In the object name table, the object's kind is stored in associated with an object name and/or the object's shape is stored in associated with a shape name. At this time, the keyword selecting section selects an object name corresponding to the object's kind and/or a shape name corresponding to the object's shape by searching the word table and describes the object name and/or the shape name as the keyword in the tag.

The tag production device may include a color name conversion table in which the object name and/or the shape name, an original color name of the object, and a common color name corresponding to the original color name are stored in association with each other. At this time, the keyword selecting section selects a corresponding original color name by searching the color name conversion table based on the object name and/or the shape name, and the color name of the characteristic color, and describes the corresponding original color name as the keyword in the tag.

The tag production device may include a color impression table in which a plurality of color combinations and color impressions obtained from the color combinations are stored in association with each other. At this time, the keyword selecting section selects a corresponding color impression by searching the color impression table based on the characteristic colors extracted by the characteristics extracting section, and describes the corresponding color impression as the keyword in the tag.

The characteristics extracting section may extract time information such as created date and time of the content. At this time, the keyword selecting section selects a word associated with the time information by searching the word table that stores words related to date and time. The word selected by the keyword selecting section is described as the keyword in the tag.

The characteristics extracting section may extract location information such as a created place of the content. At this time, the keyword selecting section selects a word associated with the location information by searching the word table that stores words related to location and place. The word selected by the keyword selecting section is described as the keyword in the tag.

According to another embodiment of the present invention, the content register device further includes a schedule management device having an event input device and an event memory device. The event input device inputs a name of an event, and date and time of the event. The event memory device memorizes the event's name and the event's date and time in association with each other. At this time, the tag production device includes a schedule associating section for selecting an event's name and an event's date and time corresponding to time information such as created date and time of the content by searching the event memory device based on the time information, and describes the event's name and the event's date and time as the keywords in the tag.

In the thesaurus, the words are arranged in tree-structure according to conceptual broadness of the words. The score acquiring section acquires the score according to the number of words between the keyword and the associated word.

The content register device may further include a weighting device for assigning a weight to the keyword. The weighting device assigns the weight based on the number of the keywords existing in the content database.

A content register method and a content register program of the present invention includes the steps of: inputting content; automatically producing a tag in which a keyword representing characteristics of the content is described; acquiring an associated word of the keyword by searching a thesaurus having words sorted and arranged in groups that have similar meanings; acquiring a score representing the degree of association between the associated word and the keyword with use of the thesaurus; and registering the content, the tag, the associated word and the score in association with each other.

According to the present invention, the keywords are automatically added to the content when the content is registered. Owing to this, the content registration can be facilitated. In addition, since the keywords are selected according to a predetermined rule, the keywords used by the person who registers the content and the searcher do not differ based on their subjectivity. Accordingly, search accuracy and percent hit rate in search can be improved.

Since the associated words are also automatically selected and registered with the keywords, the content can be searched even with ambiguous keywords by utilizing the associated words. Accordingly, a broad-ranging search can be performed. Moreover, since the score of the associated word and the weight of the keyword are also registered, an accurate search can be performed based on the degree of association between the associated word and the keyword, the level of importance of the keyword, and the like.

The keywords included in the tag are selected from a variety of characteristics such as the characteristic color extracted from the content, the time information, the location information, the object's kind and/or shape according to the image recognition, the original color of the object, the color impressions produced from various color combinations, and the like. Owing to this, a broad-ranging search can be performed. Moreover, since the event's name recorded in the schedule management device can be described as the keyword, a search based on a user's personal activity can also be performed.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram illustrating the structure of an image management device to which the present invention is applied;

FIG. 2A is an explanatory view illustrating the structure of an image file that is input to the image management device and FIG. 2B is an explanatory view illustrating the structure of the image file that has been registered in an image database;

FIG. 3 is a block diagram illustrating the structure of an image registering section;

FIG. 4 is an explanatory view illustrating an example of a word table;

FIG. 5 is an explanatory view illustrating a part of a thesaurus;

FIG. 6 is a flow chart illustrating processes of registering an image;

FIG. 7 is a flow chart illustrating processes of producing a tag;

FIG. 8 is a functional block diagram illustrating the structure of a tag production section that has image recognizing function for recognizing an object's shape and the like;

FIG. 9 is a flow chart illustrating processes of acquiring an object's name and the like;

FIG. 10 is a functional block diagram illustrating the structure of a tag production section that has function for acquiring an original color name of the object;

FIG. 11 is a flow chart illustrating processes of acquiring the original color name;

FIG. 12 is a functional block diagram illustrating the structure of a tag production section that has function for acquiring an event's name from a schedule management program;

FIG. 13 is a flow chart illustrating processes of acquiring the event's name;

FIG. 14 is a functional block diagram illustrating the structure of a tag production section that has function for acquiring a color impression from a plurality of color combinations;

FIG. 15 is a flow chart illustrating processes of acquiring the color impression;

FIG. 16 is a functional block diagram illustrating the structure of a tag production section that has function for assigning a weight to a keyword; and

FIG. 17 is a flow chart illustrating process of assigning a weight to the keyword.

### DESCRIPTION OF THE PREFERRED EMBODIMENTS

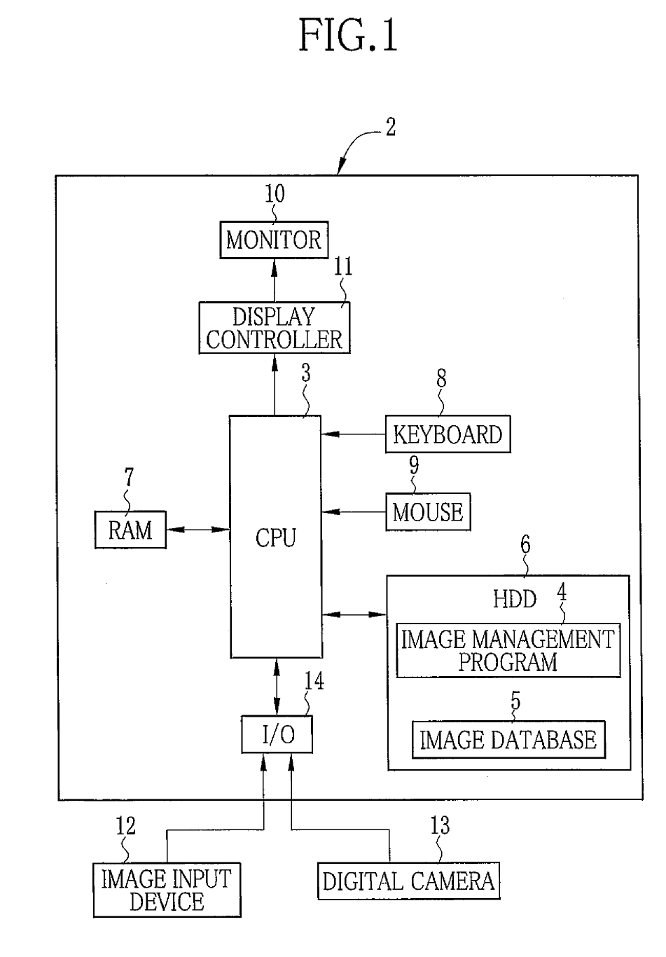

In FIG. 1, an image management device 2 includes a CPU 3 for controlling each part of the image management device 2, a hard disk drive (HDD) 6 storing an image management program 4, an image database 5 and the like, a RAM 7 to which programs and data are loaded, a keyboard 8 and a mouse 9 used for various operations, a display controller 11 for outputting a graphical user interface (GUI) and images to a monitor 10, an image input device 12 such as a scanner, and an I/O interface 14 for inputting images from external devices such as a digital camera 13, and the like. Images can also be input to the image management device 2 through a network when a network adaptor and the like are connected to the image management device 2.

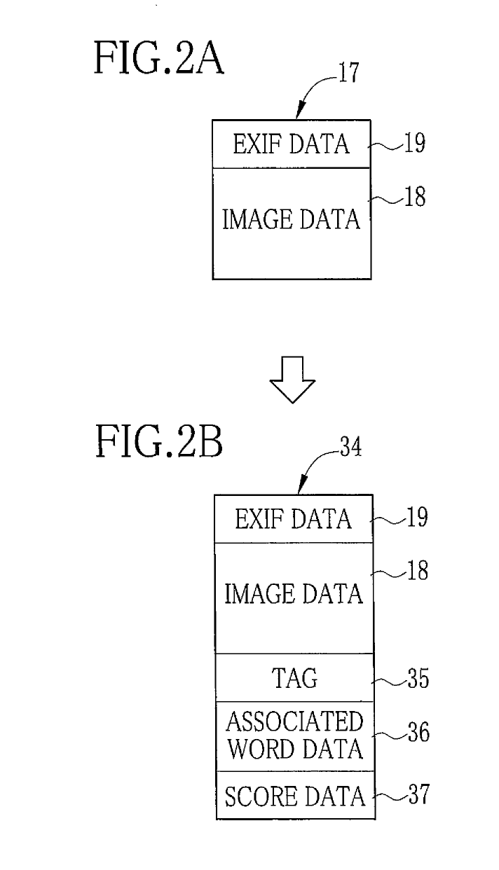

As shown in FIG. 2A, an image file 17 that is produced in the digital camera 13 complies with DCF (Design rule for Camera File system) standard. This image file 17 is composed of image data 18 and EXIF data 19. The EXIF data 19 includes information like time information such as shooting date and time, camera model, shooting conditions such as shutter speed, aperture and ISO speed, and the like. When the digital camera 13 has GPS (Global Positioning System) function, the EXIF data 19 of the image file 17 also stores location information such as latitude and longitude of a shooting place.

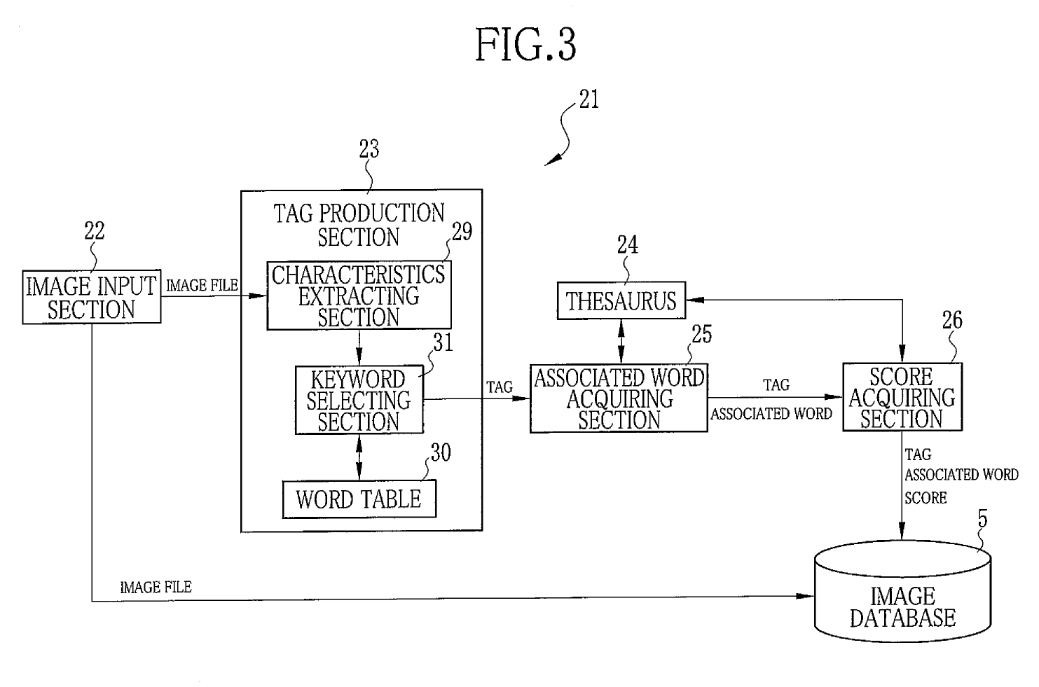

The CPU 3 operates as an image registering section 21 shown in FIG. 3 when operating based on the image management program 4. The image registering section 21 has an image input section 22, a tag production section 23, a thesaurus 24, an associated word acquiring section 25, and a score acquiring section 26. The image registering section 21 registers images in the image database 5. The image input section 22 accepts image files from the I/O interface 14 and the like and inputs the received image files to the tag production section 23 and the image database 5.

The tag production section 23 is composed of a characteristics extracting section 29, a word table 30, and a keyword selecting section 31. The tag production section 23 produces a tag 35 for data search and adds the tag 35 to the image data 18, like an analyzed image file 34 shown in FIG. 2B.

The characteristics extracting section 29 analyzes the input image file 17 and extracts characteristics that can be keywords. For example, the characteristics extracting section 29 extracts a characteristic color of an image from the image data 18 and obtains the time information such as shooting date and time and the location information such as latitude and longitude of the shooting place from the EXIF data 19. A color having highest number of pixels (color having maximal area), a color having highest pixel density, or the like may be selected as the characteristic color. The characteristic color may be extracted according to the frequency of appearance in color sample as described in Japanese Patent Laid-open Publication No. 10-143670. Note that the characteristic color may be more than one.

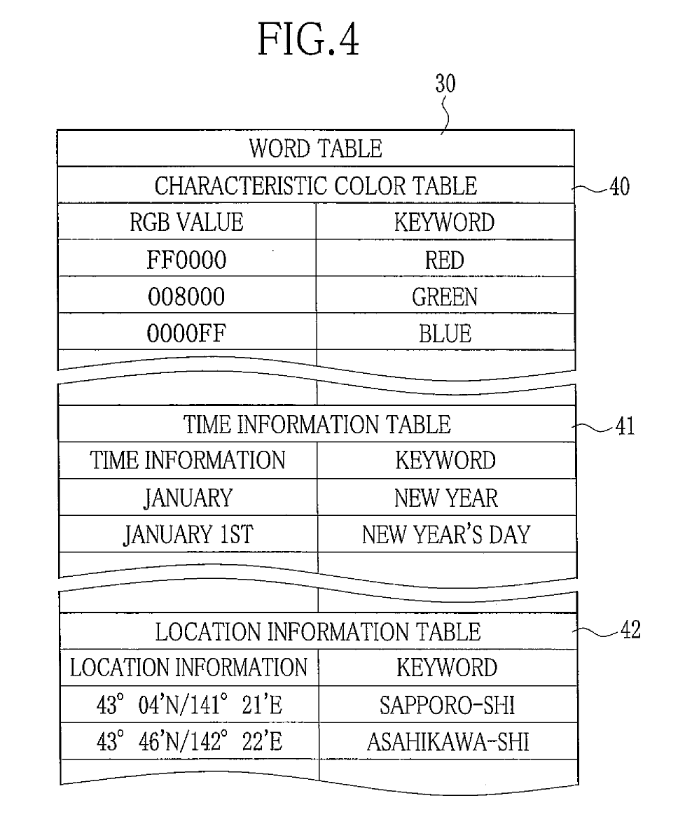

The word table 30 stores the characteristics extracted by the characteristics extracting section 29 and the words used as the keywords as being associated with each other. As shown in FIG. 4, the word table 30 is provided with a characteristic color table 40, a time information table 41, a location information table 42, and the like. In the characteristic color table 40, RGB values that represent color distribution of red, green and blue in hex of 00 to FF and their color names as the keywords are stored in association with each other. As the characteristic color table 40, for example, Netscape color palette used for producing an HTML document, HTML 3.2 standard 16-color palette, or the like may be used. The time information table 41 stores words representing seasons, holidays, time zones, and the like that correspond to the date and time as the keywords. The location information table 42 stores city names, country names, landmark names, and the like that correspond to the latitude and longitude as the keywords.

The keyword selecting section 31 searches the word table 30 based on the input characteristic color, time information and/or location information, and selects corresponding words. Then, the keyword selecting section 31 produces the tag 35 having the selected words as the keywords and inputs the tag 35 to the associated word acquiring section 25.

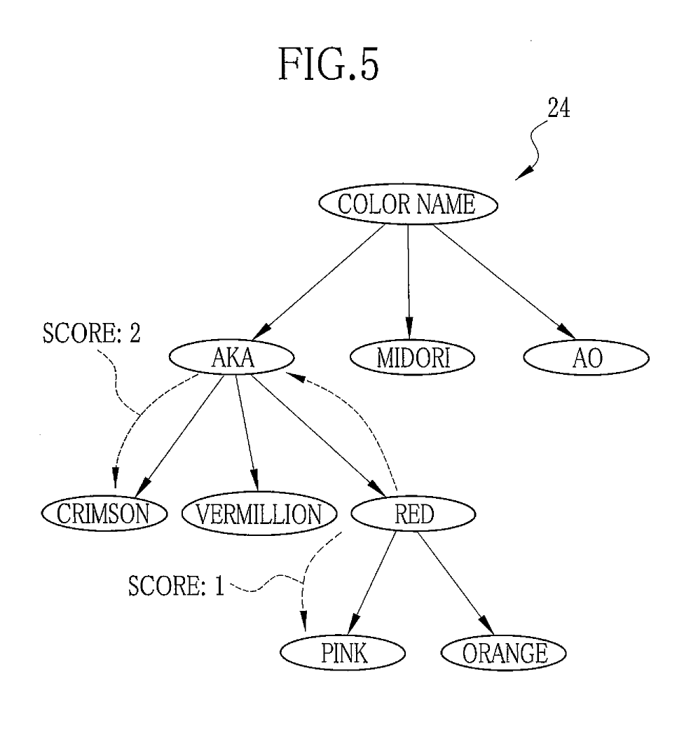

The associated word acquiring section 25 searches the thesaurus 24 for words associated to the keywords described in the tag 35 and inputs the words to the score acquiring section 26. In the thesaurus 24, words are sorted and arranged in groups that have similar meanings, and the words are arranged in tree-structure according to conceptual broadness of the words. As shown in FIG. 5, when the keyword is “RED”, this word is arranged under “COLOR NAME” and “AKA (Japanese word meaning red)”. At the same level as “RED”, there are “CRIMSON”, “VERMILLION” and the like arranged as associated words of “RED”. In addition, other similar color names like “PINK”, “ORANGE” and the like are also registered in association with “RED”. In FIG. 5 a word “AO” is a Japanese word meaning blue and a word “MIDORI” is a Japanese word meaning green.

The associated words acquired in the associated word acquiring section 25 are added as associated word data 36 to the analyzed image file 34, as shown in FIG. 2B. The range of the associated words is not particularly limited, but may be set in accordance with available recording space of the associated word data 36.

The score acquiring section 26 acquires a score representing the degree of association of the associated word and the keyword with use of the thesaurus 24. As shown in FIG. 5, for example, when the keyword is “RED” and the associated word is “PINK”, “1” that is internodal distance between them is added as the score. When the associated word is “CRIMSON”, “2” is added as the score. The score acquired in the score acquiring section 26 is added as score data 37 to the analyzed image file 34, as shown in FIG. 2B. The score may be calculated by changing the adding number from level to level. Other calculating methods can also be applied to the score acquiring method.

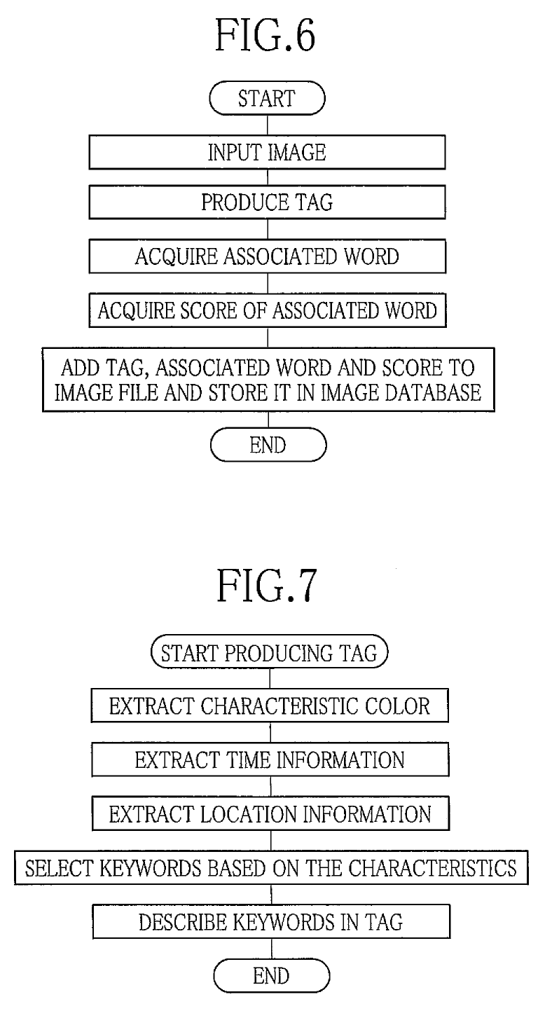

Hereinafter, the operation of the above embodiment will be explained with referring to flow charts shown in FIGS. 6 and 7. The CPU 3 operates as the image input section 22, tag production section 23, thesaurus 24, associated word acquiring section 25, and score acquiring section 26, based on the image management program 4. The image input section 22 accepts the image files 17 from the I/O interface 14 and the like and inputs the received image files 17 to the tag production section 23.

The characteristics extracting section 29 extracts the characteristic color of the image from the image data 18 of the image file 17. The characteristics extracting section 29 may also extract the time information such as shooting date and time and/or the location information such as shooting place from the EXIF data 19 of the image file 17. The keyword selecting section 31 searches the word table 30 and selects words corresponding to the characteristics extracted by the characteristics extracting section 29, as the keywords.

For example, when the characteristic color of the image data 18 has the RGB value of FF0000 representing the color red, the color name “RED” is selected from the color table 40 as the keyword. When the time information is “JANUARY 1ST”, words like “NEW YEAR” and/or “NEW YEAR'S DAY” are selected from the time information table 41 as the keyword. Based on the latitude and longitude of the location information, the city name like “SAPPORO-SHI” is selected from the location information table 42 as the keyword. The keyword selecting section 31 selects such words as the keywords and produces the tag having these keywords described. The tag is input to the associated word acquiring section 25.

The associated word acquiring section 25 searches the thesaurus 24 for words associated to the keywords of the tag and selects the associated words. For example, from the keyword “RED”, associated words like “AKA”, “CRIMSON”, “VERMILLION” and so on, and similar color names like “PINK”, “ORANGE” and so on are selected. From the keywords “NEW YEAR” and/or “NEW YEAR'S DAY”, associated words like “MORNING OF NEW YEAR'S DAY”, “COMING SPRING” and so on are selected. From the keyword “SAPPORO-SHI”, associated words like “HOKKAIDO”, “CENTRAL HOKKAIDO” and the like are selected. The associated words and the tag are input to the score acquiring section 26.

The score acquiring section 26 acquires a score representing the degree of association of the associated word and the keyword with use of the thesaurus 24. The score is calculated according to the internodal distance between the keyword and the associated word. For example, the score of the associated word “AKA” to the keyword “RED” is “1”, and the score of the associated word “CRIMSON” to the keyword “RED” is “2”. The score is input to the image database 5 together with the tag and the associated words.

The image database 5 adds the tag, the associated words, and the score to the image file 17 input from the image input section 22 and produces the analyzed image file 34, and stores this image file 34 to a predetermined memory area. The keywords and associated words in the tags enable the image file search.

In this way, since the keywords representing the characteristics of the input image are automatically added to the image file, the person who registers the image does not need to input the keywords. Owing to this, the image registration is facilitated. In addition, since the keywords are selected according to the predetermined rule, the keywords can be easily known by analogy, which improves search accuracy and percent hit rate in search. Since the image search can be performed not only with the keywords but also with the associated words, a broad-ranging search can be performed. When the score, which assigns a weight to the keyword, is used to output the image search result, the image search can be performed with higher accuracy.

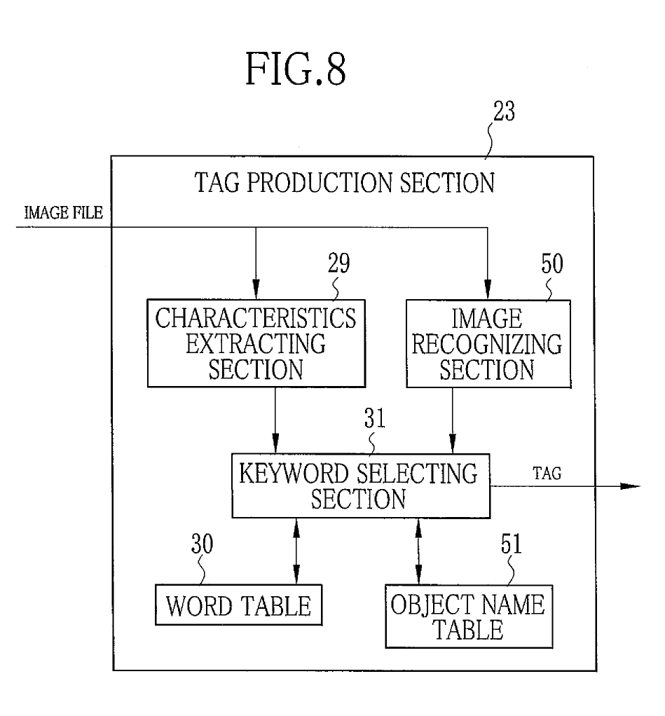

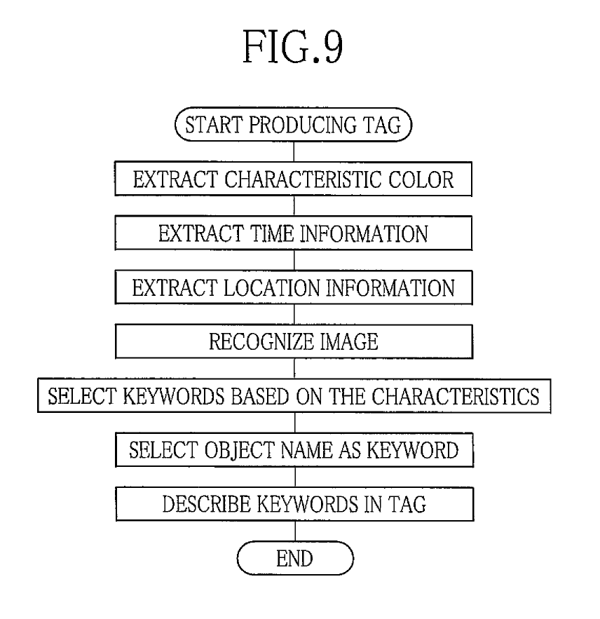

In the above embodiment, the characteristic colors are extracted from the image data 18. It is also possible to recognize and use a kind and/or a shape of an object in the image as the keywords. As shown in FIG. 8, for example, the tag production section 23 may be provided with an image recognizing section 50 and an object name table 51. The image recognizing section 50 recognizes a kind and/or a shape of an object in the image data 18. The object name table 51 stores the object's kind in association with an object name and/or the object's shape in association with a shape name. As shown in a flow chart of FIG. 9, the image recognizing section 50 performs the image recognition before or after, or in parallel with the characteristics extraction by the characteristics extracting section 29. The keyword selecting section 31 selects an object name corresponding to the object's kind and/or a shape name corresponding to the object's shape by searching the object name table 51 as well as the word table 30, and describes the object name and/or the shape name as the keywords in the tag. Owing to this, the image search can be performed using the name and/or the shape of the object in the image.

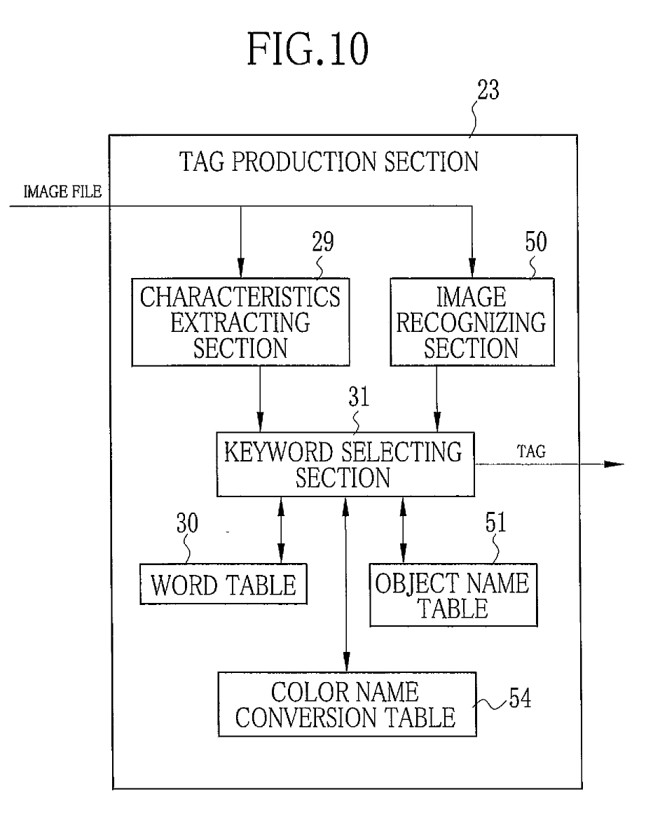

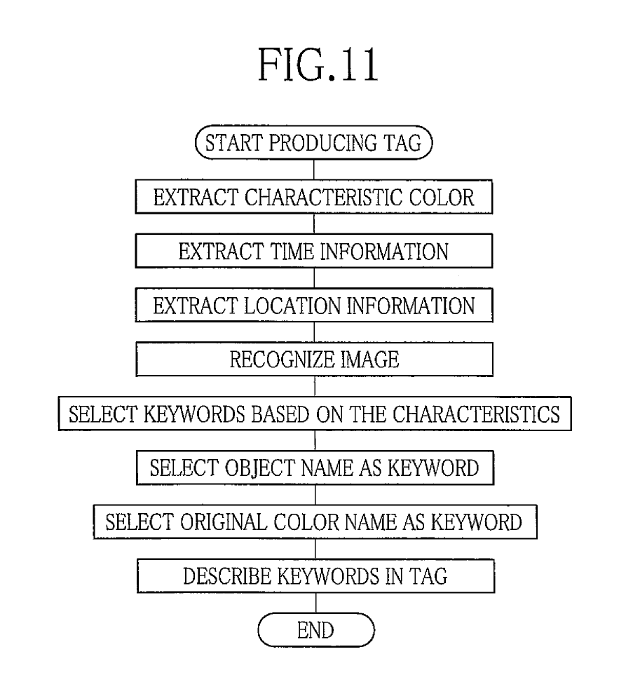

Each product may use original color names. The image search may be performed with use of such original color names. As shown in FIG. 10, for example, the tag production section 23 may be provided with a color name conversion table 54. In the color name conversion table 54, the object name and/or the shape name, an original color name of the object, and a common color name corresponding to the original color name are stored in association with each other. As shown in a flow chart of FIG. 11, the keyword selecting section 31 selects an original color name unique to the product by searching the color name conversion table 54 using the object name and/or the shape name of the object, and the color name of the characteristic color, and describes the selected original color name as the keyword in the tag. Owing to this, more broad-ranging image search can be performed.

The image management program 4 may be operated on a general-purpose personal computer (PC). It is common that a schedule management program is installed to the PC to manage a schedule. The schedule input to the schedule management program may be used for the image management.

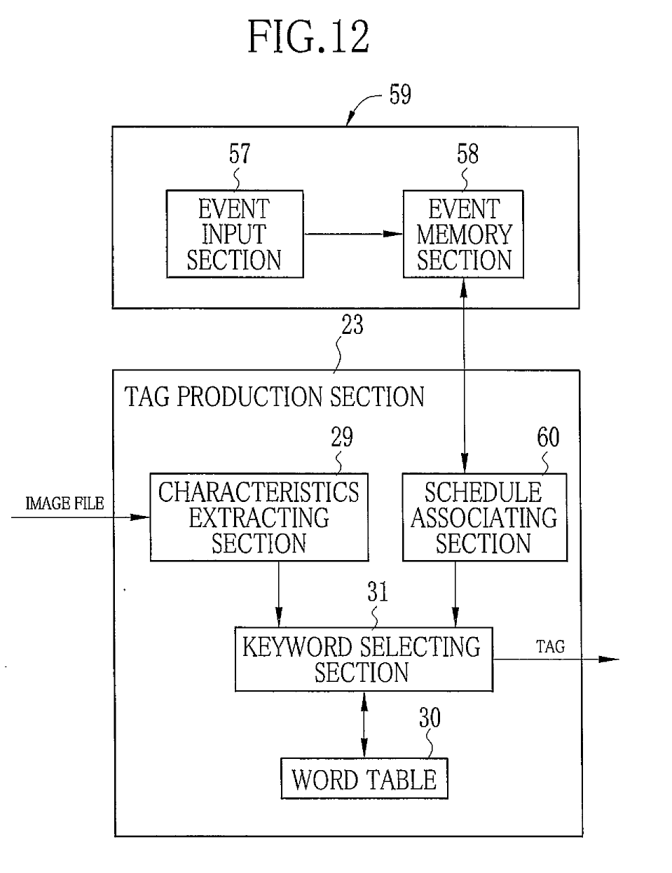

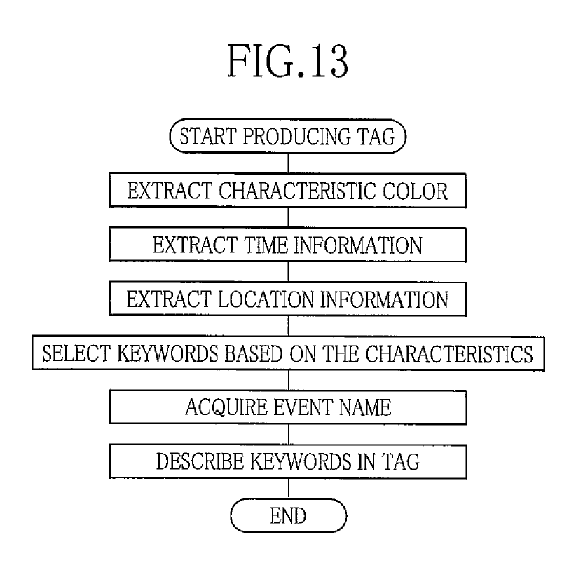

As shown in FIG. 12, for example, a schedule management program having an event input section 57 and an event memory section 58 is installed to a PC 59. The event input section 57 inputs a name of an event and date and time of the event. The event memory section 58 memorizes the event's name and the event's date and time in association with each other. The tag production section 23 is provided with a schedule associating section 60. The schedule associating section 60 searches the event memory section 58 based on time information, which is extracted by the characteristics extracting section 29. The schedule associating section 60 then obtains an event's name and an event's date and time corresponding to the time information. As shown in a flow chart of FIG. 13, the event's name acquired by the schedule associating section 60 is input to the keyword selecting section 31, and described in the tag together with other keywords. Owing to this, more broad-ranging image search can be performed.

It is known that various color impressions can be obtained from a plurality of color combinations. For example, a color combination mainly composed of reddish and bluish colors having low brightness may provide an impression of elegance. A color combination mainly composed of grayish colors having medium brightness may provide impressions of natural, ecological, and the like. Such color impressions can be used for the image search.

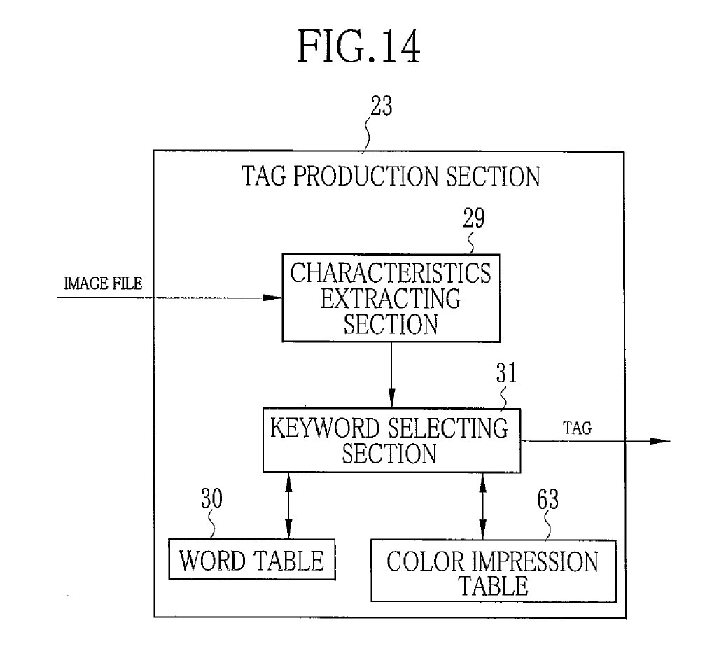

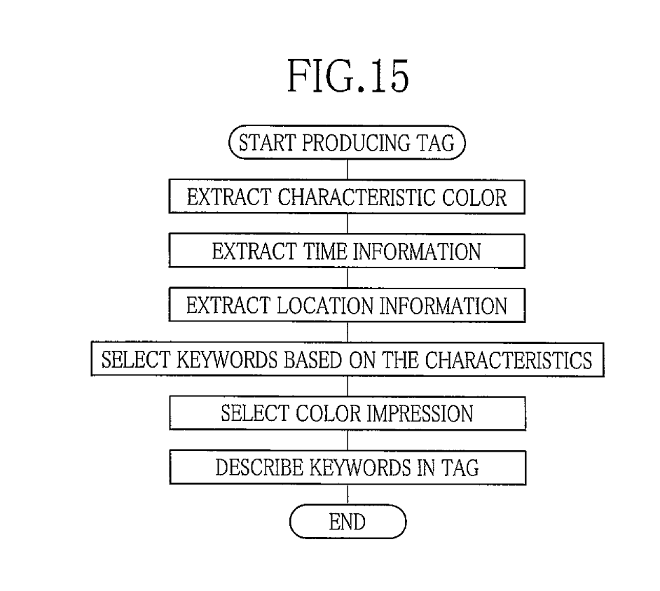

As shown in FIG. 14, the tag production section 23 is provided with a color impression table 63. In the color impression table 63, a plurality of color combinations and color impressions obtained from the color combinations are stored in association with each other. As shown in a flow chart of FIG. 15, the keyword selecting section 31 selects a corresponding color impression by searching the color impression table 63 based on a plurality of characteristic colors extracted by the characteristics extracting section 29. The selected color impression is described as the keyword in the tag. For this configuration, the image search can be performed using color impressions of images, which facilitates more broad-ranging image search.

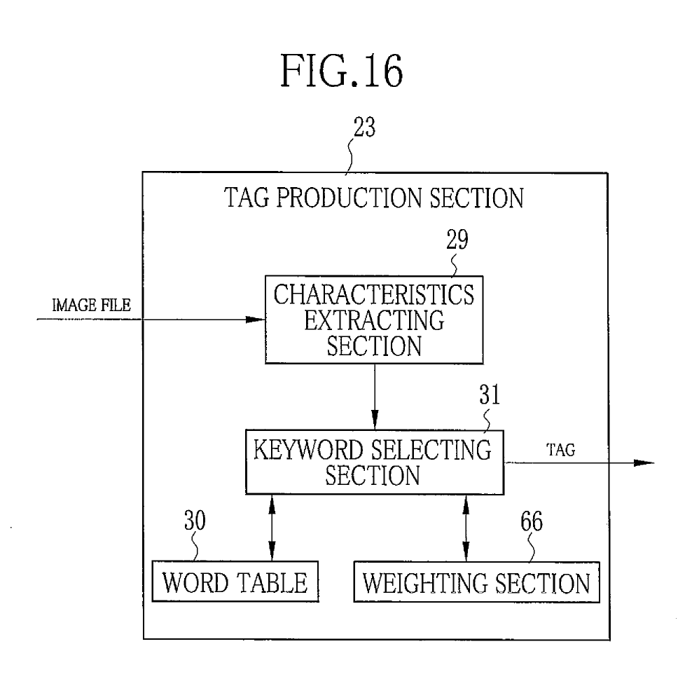

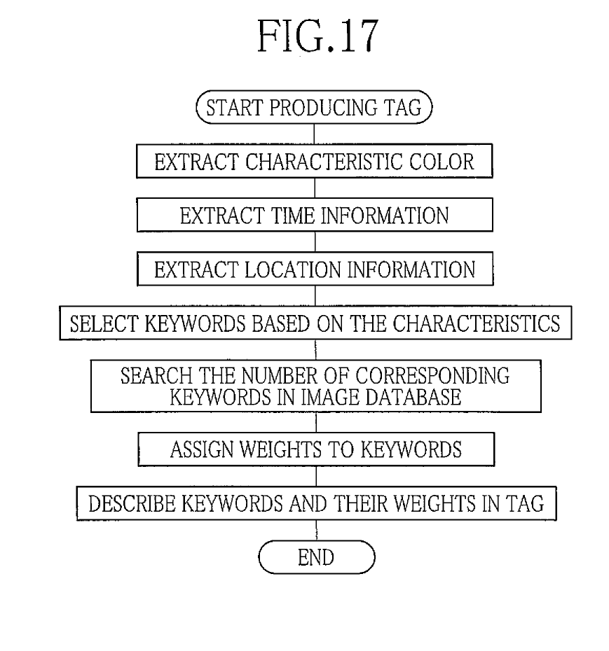

It is also possible to assign a weight to the keyword. As shown in FIG. 16, for example, the tag production section 23 is provided with a weighting section 66. The weighting section 66 assigns a weight to the keyword, which is selected by the keyword selecting section 31. The keyword and the weight are described in the tag. As shown in a flow chart of FIG. 17, the weighting section 66 counts the number of the keywords existing in the image database 5. The weighting section 66 determines the weights depending on the number of the existing keywords. For example, a more weight is assigned to the keyword that is contained in the database 5 most, or a more weight is assigned to the keyword that is contained in the database 5 least.

When the image search results are displayed on the monitor 10, the keywords are displayed in decreasing order of weight from the top. Owing to this, the level of importance of each keyword is reflected on the search results, which facilitates more broad-ranging search. When the weights are determined according to the number of keywords in the image database 5, the weights change as images are newly registered. It is therefore preferable to reevaluate the weight assigned to each keyword every time an image is registered. Although the weights of the keywords are registered separately from the scores of the associated words, the weights and the scores may be connected (associated) using some sort of calculation technique.

Although the present invention is applied to the image management device in the above embodiments, the present invention can be applied to other kinds of devices that deal with images, such as digital cameras, printers, and the like. Moreover, the present invention can be applied to content management devices that deal not only with images but also with other kinds of data such as audio data and the like.

Various changes and modifications are possible in the present invention and may be understood to be within the present invention.

What is claimed is:

1. A content register device comprising:
a content input device for inputting content;
a tag production device for automatically producing a tag in which a keyword representing characteristics of said content is described;
a thesaurus having words sorted and arranged in groups that have similar meanings;
an associated word acquiring device for acquiring an associated word of said keyword by searching said thesaurus;
a score acquiring device for acquiring a score representing the degree of association between said associated word and said keyword with use of said thesaurus; and
a content database for registering said content, said tag, said associated word and said score in association with each other.

2. The content register device according to claim 1, wherein said tag production device including:
a characteristics extracting section for extracting said characteristics that can become said keyword by analyzing said content or metadata attached to said content;
a word table storing said characteristics and a word in association with each other; and
a keyword selecting section for selecting a word corresponding to said characteristics by searching said word table and describing said word as said keyword in said tag.

3. The content register device according to claim 2, wherein
when said content is an image, said characteristics extracting section extracts at least one characteristic color of said image,
said word table stores said characteristic color and a color name in association with each other, and
said keyword selecting section selects a color name corresponding to said characteristic color by searching said word table and describes said color name as said keyword in said tag.

4. The content register device according to claim 3, wherein said tag production device further including:
an image recognizing section for recognizing a kind and/or a shape of an object in said image; and
an object name table storing said object's kind in association with an object name and/or said object's shape in association with a shape name, wherein
said keyword selecting section selects an object name corresponding to said object's kind and/or a shape name corresponding to said object's shape by searching said word table and describes said object name and/or said shape name as said keyword in said tag.

5. The content register device according to claim 4, wherein said tag production device further including:
a color name conversion table storing said object name and/or said shape name, an original color name of said object, and a common color name corresponding to said original color name in association with each other, wherein
said keyword selecting section selects a corresponding original color name by searching said color name conversion table based on said object name and/or said shape name, and said color name of said characteristic color, and describes said corresponding original color name as said keyword in said tag.

6. The content register device according to claim 3, wherein said tag production device including:
a color impression table storing a plurality of color combinations and color impressions obtained from said color combinations in association with each other, wherein
said keyword selecting section selects a corresponding color impression by searching said color impression table based on said characteristic colors extracted by said characteristics extracting section, and describes said corresponding color impression as said keyword in said tag.

7. The content register device according to claim 2, wherein
said characteristics extracting section extracts time information such as created date and time of said content,
said word table stores words related to date and time, and
said keyword selecting section selects a word associated with said time information by searching said word table and describes said word as said keyword in said tag.

8. The content register device according to claim 2, wherein
said characteristics extracting section extracts location information such as a created place of said content,
said word table stores words related to location and place, and
said keyword selecting section selects a word associated with said location information by searching said word table and describes said word as said keyword in said tag.

9. The content register device according to claim 1, further comprising:
a schedule management device having an event input device and an event memory device, said event input device inputting a name of an event, and date and time of said event, said event memory device memorizing said event's name and said event's date and time in association with each other, wherein
said tag production device including:
a schedule associating section for selecting an event's name and an event's date and time corresponding to time information such as created date and time of said content by searching said event memory device based on time information such as created date and time of said content, and describes said event's name and said event's date and time as said keywords in said tag.

10. The content register device according to claim 1, wherein said thesaurus has said words arranged in tree-structure according to conceptual broadness of said words, said score acquiring section acquiring said score according to the number of words between said keyword and said associated word.

11. The content register device according to claim 1, further comprising:
a weighting device for assigning a weight to said keyword.

12. The content register device according to claim 11, wherein said weighting device assigns the weight based on the number of said keywords existing in said content database.

13. A content register method, comprising the steps of:
inputting content;
automatically producing a tag in which a keyword representing characteristics of said content is described;
acquiring an associated word of said keyword by searching a thesaurus having words sorted and arranged in groups that have similar meanings;
acquiring a score representing the degree of association between said associated word and said keyword with use of said thesaurus; and
registering said content, said tag, said associated word and said score in association with each other.

14. A content register program enabling a computer to execute the steps of:
inputting content;
automatically producing a tag in which a keyword representing characteristics of said content is described;
acquiring an associated word of said keyword by searching a thesaurus having words sorted and arranged in groups that have similar meanings;
acquiring a score representing the degree of association between said associated word and said keyword with use of said thesaurus; and
registering said content, said tag, said associated word and said score in association with each other.
